(19) United States
(12) Patent Application Publication
(10) Pub. No.: US 2015/0068959 A1
(43) Pub. Date: Mar. 12, 2015

(54) CENTRIFUGAL FILTRATION DEVICE AND CELL SEPARATION SYSTEM WITH THE SAME

(71) Applicant: Chong Zheng, Guangzhou (CN)

(72) Inventor: Chong Zheng, Guangzhou (CN)

(21) Appl. No.: 14/547,159

(22) Filed: Nov. 19, 2014

Related U.S. Application Data
(63) Continuation of application No. PCT/CN2012/086694, filed on Dec. 14, 2012.

(51) Int. Cl. B01D 33/067; B01D 33/80

(52) U.S. Cl. CPC B01D 33/067; B01D 33/804
USPC 210/141; 210/380.1

(57) ABSTRACT

The present invention directs to a centrifugal filtration device, for separating living cells, including a spindle (28), a rotary arm (211) which is connected vertically to the spindle (28) and rotates as the spindle rotates, and a microporous membrane filter (31) which is mounted on the rotary arm (211). The microporous membrane filter (31) includes an inlet (311), an outlet (312), a front cavity (313) having the inlet (311) formed thereon, a rear cavity (314) having the outlet (312) formed thereon, and a filter membrane (315) arranged between the front cavity and the rear cavity; the diameter of each filter pore formed in the filter membrane is smaller than that of the cell which needs to be separated. The present invention also discloses a cell separation system.

### CROSS-REFERENCE TO RELATED APPLICATIONS

This present application is a Continuation Application of PCT application No. PCT/CN2012/086694 filed on Dec. 14, 2012, the contents of which are hereby incorporated by reference.

### FIELD OF THE INVENTION

The present invention relates to biological cell separation field, especially for a centrifugal filtration device and a cell separation system having a microporous membrane filter, and a rapid cell separation method is obtained by using this system.

### BACKGROUND OF THE INVENTION

The best treatment of disease is reconstruction of living tissue and growing tissue which is worn out by old age or disease into new tissue, this treatment is called “Cell Treatment”. The cell treatment has a century's history, and is widely used in all filed of tumor treatment, liver treatment and dermabrasion, and it has vast development prospects.

The basic question for cell treatment is separating target cell. In prior art, cell separation is carried out by centrifuges; this separating method not only has fussy operation, but also results in mechanical trauma and pollution to cell, owing to the operation which requires drawing out and putting in cell sap again and again, and this kind of operation is strict with the laboratory environment, which impacts cell quality, and increases cost for cell separation.

Consequently, the improved device, system and method for cell separation are needed.

### SUMMARY OF THE INVENTION

One purpose of the present invention is to provide a centrifugal filtration device with simple structure and easy operation, this device is capable of separating cells rapidly in a fully sealed system, which decreases cell damage during the separation process, and avoids cell population, and the cell separation process could be automatically controlled by the computer.

In order to achieve the above purpose, the present invention provides the following technical solution:

A centrifugal filtration device, for separating living cells, including a spindle, a rotary arm which is connected vertically to the spindle and rotating as the spindle rotates, and a microporous membrane filter which is mounted on the rotary arm; and the microporous membrane filter includes an inlet, an outlet, a front cavity having the inlet formed thereon, a rear cavity having the outlet formed thereon, and a filter membrane arranged between the front cavity and the rear cavity; the diameter of each filter pore formed in the filter membrane is smaller than that of the cell which needs to be separated; the inlet and the front cavity are arranged on a far end referring to the rotary arm, and the outlet and the rear cavity are arranged on a near end referring to the rotary arm; the water in the cell suspension, the biological particle and the biomolecules pass through the filter membrane owing to the flowing fluid pressure, and the cells are blocked by the filter membrane and flung from the filter membrane to deposit in the front cavity due to the centrifugal force.

Preferably, the length of the rotary arm is 10-30 cm, the rotation speed of the rotary arm is 500-1500 revolutions per minute, and the centrifugal force produced by the rotary arm is 100-500 g.

Preferably, the cross section of the microporous membrane filter is round or square.

Preferably, the diameter of the filter pore formed in the filter membrane is 1-30 um.

Preferably, the filter membrane is made of polyolefins or polyamides material.

Preferably, the filter membrane is made of polypropylene, mixed cellulose, PE material or nylon material.

Preferably, the inlet of the microporous membrane filter is connected to a inlet tube, which is connected to a pipe assembly via a rotary joint; and the rotary joint is mounted on a holder which is arranged up over the axis of the rotary arm, a fixed component of the rotary joint is communicated to the pipe assembly, a rotary component of the rotary joint is communicated to the microporous membrane filter via the inlet tube, and the microporous membrane filter is capable of filtering cell suspension continuously while the spindle revolves.

The second purpose of the present invention is to provide a cell separation system having said centrifugal filtration device, especially having a microporous membrane filter, with simple structure and easy operation. This cell separation system provides a fully sealed system for separating cells automatically, which could avoid cell population.

In order to achieve the above purpose, the present invention provides the following technical solution:

A cell separation system, characterized by including: a disposable fully sealed piping system and an instrument system; wherein the disposable fully sealed piping system includes a microporous membrane filter, a primary filter, a rotary joint, a disposable syringe, a equilibrium liquid container, a cell suspension container, an enzyme solution container, and a pipe assembly; the microporous membrane filter includes an inlet, an outlet, a front cavity having the inlet formed thereon, a rear cavity having the outlet formed thereon, and a filter membrane arranged between the front cavity and the rear cavity; the diameter of each filter pore formed in the filter membrane is smaller than that of the cell which needs to be separated; the inlet and the front cavity are arranged further away from the point where the centrifugal force is produced than the outlet and the rear cavity are arranged, and the water in the cell suspension, the biological particle and the biomolecules pass through the filter membrane owing to the flowing fluid pressure, and the cells are blocked by the filter membrane and flung from the filter membrane to deposit in the front cavity due to the centrifugal force; the pipe assembly includes a first pipe, a second pipe, a third pipe, a fourth pipe, a fifth pipe, a sixth pipe and a seventh pipe; the cell suspension container is arranged upside down, whose opening is communicated to the first pipe; the primary filter is mounted on the first pipe; the equilibrium liquid container is arranged upside down, whose opening is communicated to the second pipe, and the second pipe is connected to the first pipe; one end of the third pipe is communicated to the junction between the first pipe and the second pipe, and the other end is communicated to the disposable syringe; one end of the fourth pipe is communicated to the disposable syringe, the other end is communicated to a fixed end of the rotary joint; one end of the fifth pipe is communicated to a rotary end of the rotary joint, the other end is communicated to the inlet tube of the microporous membrane filter; one end of the sixth pipe is communicated to the outlet of the microporous membrane filter, the other end is communicated to the waste collection tank; one end of the seventh pipe is communicated to the junction between the first pipe and the second pipe, and the other end is connected to the enzyme solution container; the instrument system includes a rotary arm assembly, an injection pump, a temperature control unit for equilibrium liquid, a temperature control unit for cell suspension, a vibrator for cell suspension, and an electromagnetic controlling valve; an end of the rotary arm assembly is mounted on the microporous membrane filter, a spindle which drives the rotary arm and a rotation axis of the rotary joint are on a straight line; the disposable syringe is controlled by the injection pump; the temperature control unit for equilibrium liquid is arranged outside the equilibrium liquid container, to heat the equilibrium liquid and control its temperature; the temperature control unit for cell suspension is arranged outside the cell suspension container, to heat the cell suspension and control its temperature; the cell suspension container and the temperature control unit for cell suspension are arranged on the vibrator for cell suspension, which oscillates the cell suspension container automatically with the frequency predetermined by the computer; the electromagnetic controlling valve includes a first controlling valve, a second controlling valve, a third controlling valve, and a fourth controlling valve; the first controlling valve is mounted on the first pipe, and arranged in front of the junction between the first pipe and the second pipe; the second controlling valve is mounted on the second pipe; the third controlling valve is mounted on the fourth pipe, and arranged between the rotary joint and the disposable syringe; and the fourth controlling valve is mounted on the seventh pipe.

Preferably, the diameter of each filter pore formed in the primary filter is larger than that of the target cell, and the diameter of the filter pore of the primary filter is 200-300 mesh.

Preferably, the electromagnetic controlling valve is electromagnetic pinch valves, to control the opening and closing of the pipe assembly.

Preferably, the front cavity and the rear cavity are separated by the filter membrane, the inlet is arranged at the top or a sidewall of the front cavity, and the outlet is arranged at the bottom or a sidewall of the rear cavity.

Preferably, the filter membrane is hydrophilic membrane.

Preferably, the diameter of the filter pore formed in the filter membrane is 1-30 um.

Preferably, the filter membrane is made of polyolefins or polyamides material.

Preferably, the filter membrane is made of polypropylene, mixed cellulose, PE material or nylon material.

The advantage of the present invention is that: the centrifugal filtration device and the cell separation system having said centrifugal filtration device with simple structure and easy operation, are capable of separating cells rapidly in a fully sealed system, which decreases cell damage during the separation process, and avoids cell population, the cell separation process could be automatically controlled by the computer, and the cell separation system has low demand in laboratory.

### BRIEF DESCRIPTION OF THE DRAWINGS

FIG. 1 is a schematic diagram showing a centrifugal filtration device according to an embodiment of the present invention;

FIG. 2 is a lateral diagram showing the centrifugal filtration device according to an embodiment of the present invention;

FIG. 3 is a schematic diagram showing the microporous membrane filter of the centrifugal filtration device;

FIG. 4 is a schematic diagram showing the rotary joint which is connected to the inlet tube of the microporous membrane filter as shown in FIG. 1; and

FIG. 5 is a schematic diagram showing a cell separation system having the centrifugal filtration device with the microporous membrane filter shown in FIG. 1.

### DETAILED DESCRIPTION OF ILLUSTRATED EMBODIMENTS

The embodiments of the present invention are disclosed in detail by combining with figures below. All the following are the preferred embodiments of the present invention, which is not the limitation of the protection of the present invention.

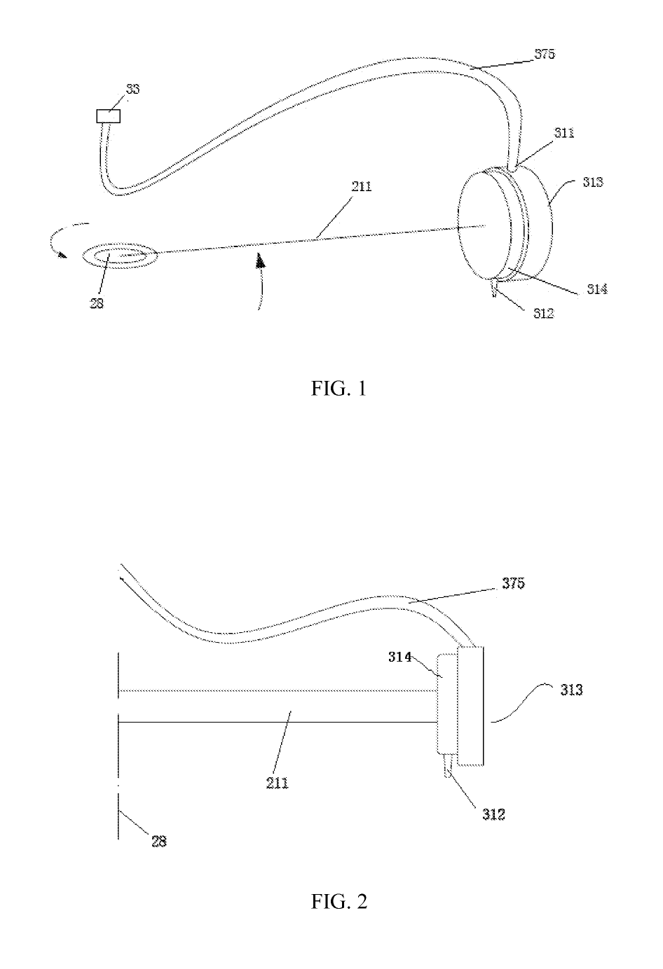

FIGS. 1, 2 and 3 show the centrifugal filtration device according to an embodiment of the present invention, and the centrifugal filtration device for separating cells includes a spindle 28, a rotary arm 211 which is connected vertically to the spindle and rotating as the spindle rotates, and a microporous membrane filter 31 which is mounted on a far end referring to the rotary arm.

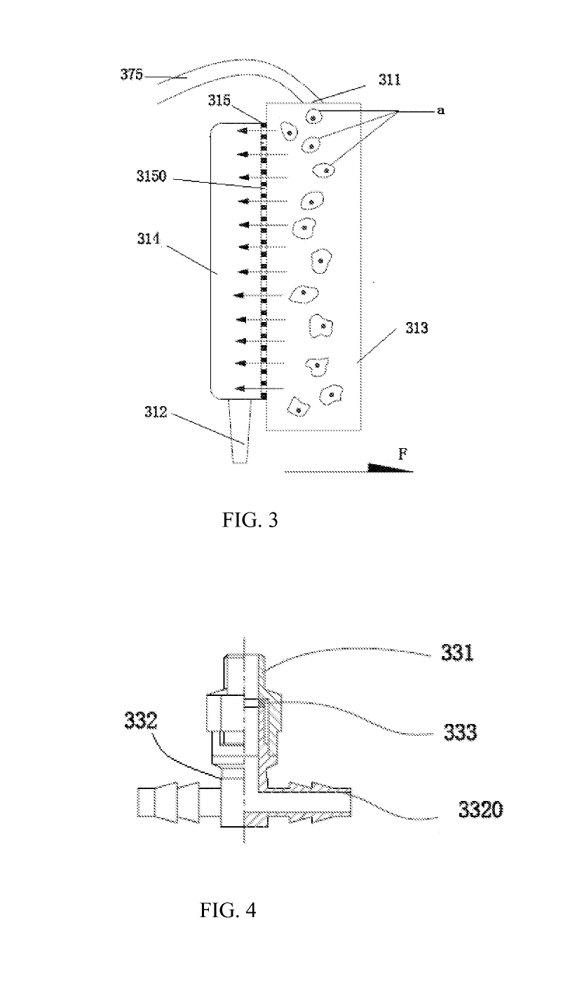

The microporous membrane filter 31 includes an inlet 311, an outlet 312, a front cavity 313 communicated to the inlet, a rear cavity 314 communicated to the outlet, and a filter membrane 315 arranged between the front cavity 313 and the rear cavity 314. Preferably, the inlet 311 is formed at the top of the front cavity 313, and the outlet 312 is formed at the bottom of the rear cavity 314, so that the liquid could flow due to the flowing fluid pressure produced by the injection, as shown in FIG. 3.

The filter membrane 315 is hydrophilic membrane, and is made of polyolefins or polyamides material. Preferably, the filter membrane is made of polypropylene, mixed cellulose, PE material or nylon material. The diameter of the filter pore 3150 formed in the filter membrane 315 is smaller than that of the cell which needs to be separated, so that the cells are blocked by the filter membrane and remain in the front cavity 313, and water and biomolecules pass through the filter membrane and run into the rear cavity 314, and then drain out of the outlet 312. In general, the diameter of the cell is 5-30 um, therefore the diameter of the filter pore 3150 of the filter membrane 315 is smaller than 5 um. Preferably, the diameter of the filter pore of the filter membrane is 1-30 um; in an optimum embodiment, the diameter of the filter pore is 3 um-5 um.

In this embodiment, the microporous membrane filter 31 has a cavity formed therein whose shape look like a round cake; the surface of the filter membrane which the liquid runs in is arranged on a far end referring to the rotary arm, and the surface of the filter membrane which the liquid runs out is arranged on a near end referring to the rotary arm. The rotary arm rotates to produce centrifugal force, so that the cells are blocked by the filter membrane and flung from the filter membrane because the cells have bigger size to withstand more centrifugal force, and the filter pores 3150 keep open, to make the water and useless or harmful biomolecules run though the filter pores under the flowing fluid pressure.

Preferably, the front cavity 313 is arranged on a far end referring to the rotary arm 211, and the rear cavity 314 is arranged on a near end referring to the rotary arm 211, that is, the location of the front cavity 313 is further away from the rotary arm 211 than that of the rear cavity 314. Therefore, the liquid flows from the inlet 311 to the outlet 312, that is the liquid flows from the end far away the rotary arm 211 towards the near end of the rotary arm 211, and this liquid flowing direction is opposite to that of the centrifugal force on the microporous membrane filter 31 while the rotary arm 211 rotates. The cells are blocked by the filter membrane 315 to remain in the front cavity 313 when the cell suspension are in the front cavity 313, and then the cells are flung from the filter membrane 315 owing to the centrifugal force, and the filter pores 3150 keep open, to make the filtering process keep constant.

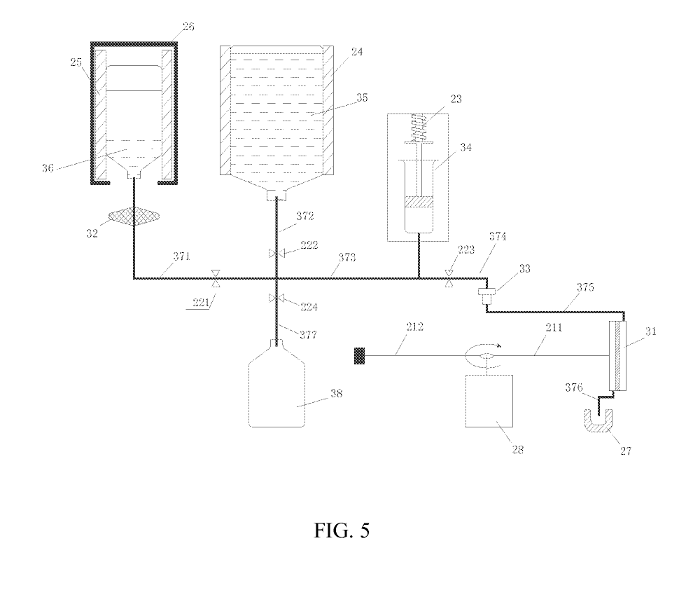

In this embodiment, an inlet tube 375 is connected to a pipe assemble via a rotary joint 33. Specifically, as shown in FIG. 4, the rotary joint 33 includes a fixed component 331 and a rotary component 332, the fixed component 331 has a chamber to receive the rotary component 332 to rotate in the fixed component 331. A seal ring 333 is arranged on the connection between the fixed component 331 and the rotary component 332. The fixed component 331 is fixed and connected to the pipe assemble, and the connecting part 3320 of the rotary component 332 is communicated to the inlet tube 375. Thus, the inlet tube 375 could rotate as the spindle 28 rotates, when the fixed component of the rotary joint is fixed. Preferably, the rotary joint 33 is arranged on the spindle 28 or its extension cord, so that the inlet tube 375 and the microporous membrane filter 31 rotate synchronously.

The cell separation system according to the present invention is described as follow.

Referring to FIG. 5, the cell separation system according to the embodiment of the present invention includes two parts, which are a disposable fully sealed piping system and an instrument system.

The disposable fully sealed piping system includes a microporous membrane filter 31, a primary filter 32, a rotary joint 33, a disposable syringe 34, an equilibrium liquid container 35, a cell suspension container 36, an enzyme solution container 38, and a pipe assembly 37. The detailed description is shown as follow.

(1) The structure of the microporous membrane filter 31 of the centrifugal filtration device has been described above.

(2) the primary filter 32 could filter out impurities in the cell suspension. In this embodiment, the primary filter 32 is arranged in the upstream referring to the liquid flowing direction, that is near the cell suspension container 36, so that some larger particles and some impurities (such as some undigested tissues and big molecule) could be filtered out, during the tissue washing and filtering process. Preferably, in this embodiment, based on abundant experiments, the primary filter 32 is a filter with 200 mesh, under such arrangement, the filter effect is the best. The filters with 200-300 mesh are all preferred in the present invention. In other embodiments of the present invention, any filter with suitable structure is all available.

(3) The structure of the rotary joint 33 of the centrifugal filtration device has been described above.

(4) The disposable syringe 34 is driven by the injection pump 23 (it will be described below), for extracting and injecting liquid.

(5) The equilibrium liquid container 35 is used to hold equilibrium liquid (also call it buffer or washing liquid), the equilibrium liquid container 35 is kept under 37° C. controlled by the temperature control unit for equilibrium liquid 24. the temperature of 37° C. comes closer to human body temperature, which helps to protect the cells. Also, the temperature control unit for equilibrium liquid 24 could be regulated for temperature in accordance with the requirement of the cell protection.

The equilibrium liquid could be phosphate buffer (PBS) or lactated ringer's solution. In this embodiment, the equilibrium liquid is lactated ringer's solution preferably, because the electrolyte concentration, PH value and osmotic pressure are very close to those of the extracellular fluids, so as to helps cell survival, washing away the collagenase of the cell sap, to eliminate the harmful influence on cells. Preferably, the temperature of the raw materials should be kept to close to human body temperature during cells extracting process, therefore the present invention provides the temperature control unit for cell suspension 25, which heats the cell suspension container 36 and control it under certain temperature, which is 37° C. in general.

(6) The cell suspension container 36 is arranged upside down in this embodiment, whose opening is arranged downward. The cell suspension container 36 is used for containing raw materials from the human body for extracting cells, the raw material could be all kinds of tissues, including but not limiting to: adipose tissue, blood, bone marrow, muscle, skin, liver, muscle membrane, placenta, umbilical cord, body fluids, secretions, and cell culture, etc; in this embodiment, the adipose tissue is separated to harvest adipose stem cells. The adipose tissue could be obtained using any suitable process in prior art, such as liposuction (using a syringe) or lipectomy. The amount of extracting adipose tissue depends on various factors, including: capability of extracting adipose tissue and the necessary amount of adipose stem cells. Preferably, in order to mix the collagenase solution with the adipose tissue quickly, and digesting the adipose tissue quickly using the collagenase, the cell suspension container 36 and the temperature control unit for cell suspension 25 are both arranged on the vibrator for cell suspension 26, to oscillate cell suspension container 36.

(7) The enzyme solution container 38 is used for preparing solution during tissue processing, and the enzyme solution is collagenase solution in this embodiment.

(8) The pipe assembly 37 a first pipe 371, a second pipe 372, a third pipe 373, a fourth pipe 374, a fifth pipe 375, a sixth pipe 376, and a seventh pipe 377.

The cell suspension container 36 is arranged upside down, whose opening is communicated to the first pipe 371, and the primary filter 32 is mounted on the first pipe 371.

The equilibrium liquid container 35 is arranged upside down, whose opening is communicated to the second pipe 372, and the second pipe 372 is communicated to the first pipe 371.

One end of the third pipe 373 is communicated to the junction between the first pipe 371 and the second pipe 372, and the other end is communicated to the disposable syringe 34.

One end of the fourth pipe 374 is communicated to the disposable syringe 34, and the other end is communicated to a fixed end of the rotary joint 33.

One end of the fifth pipe 375 is communicated to a rotary end of the rotary joint 33, and the other end is communicated to the inlet of the microporous membrane filter 31.

One end of the sixth pipe 376 is communicated to the outlet of the microporous membrane filter 31, and the other end is communicated to the waste collection tank 27.

One end of the seventh pipe is communicated to the junction between the first pipe and the second pipe, and the other end is communicated to the enzyme solution container.

In this system, when the process of cell separation is finished, the fifth pipe 375 which is connected to the inlet and the sixth pipe 376 which is connected to the outlet are cut by a thermal scissors and sealed, so that the microporous membrane filter 31 are sealed to have the cells which are needed remain therein, to store cells for use.

All pipes said above could be hard or soft, which depend on the actual requirement. In this embodiment, all pipes are made of soft material, such as polyethylene pipe which is usually used, silicon resin pipe, or any other material employed by pipes in prior art. The diameter of the pipe depends on the size or number of the tissue and the flowing speed of the liquid, etc. The pipe is capable of affording positive pressure and negative pressure produced by the syringe.

All parts of the disposable fully sealed piping system are for one time use and fully sealed, which guarantees that the process of separating cells from cell suspension is conducted in a sealed pipe system and avoids pollution.

The instrument system which could be reused of the cell separation system is described below.

Referring to FIG. 5, the instrument system includes a rotary arm 21, an electromagnetic controlling valve 22, an injection pump 23, a temperature control unit for equilibrium liquid 24, a temperature control unit for cell suspension 25, and a vibrator for cell suspension 26.

An end of a rotary arm 211 of the rotary arm assembly 21 is mounted on the microporous membrane filter 31, a spindle which drives the rotary arm of the rotary arm assembly 21 and a rotation axis of the rotary joint 33 are on a straight line, so that the rotary arm and the rotary joint rotate in synchronism. A balance member 212 with a balance block of the rotary arm assembly 21 is arranged in the opposite end of the rotary arm. The rotary arm assembly 21 is driven by the spindle 28.

The disposable syringe 34 is controlled by the injection pump 23.

The temperature control unit for equilibrium liquid 24 is arranged outside the equilibrium liquid container 35, to heat the equilibrium liquid and control its temperature.

The temperature control unit for cell suspension 25 is arranged outside the cell suspension container 36, to heat the cell suspension and control its temperature. Furthermore, the cell suspension container 36 and the temperature control unit for cell suspension 25 are arranged on the vibrator for cell suspension 26, which oscillates the cell suspension container 36 automatically with the frequency predetermined by the computer.

The electromagnetic controlling valve 22 includes a first controlling valve 221, a second controlling valve 222, a third controlling valve 223, and a fourth controlling valve 224.

The first controlling valve 221 is mounted on the first pipe 371, and arranged in front of the junction between the first pipe 371 and the second pipe 372.

The second controlling valve 222 is mounted on the second pipe 372.

The third controlling valve 223 is mounted on the fourth pipe 374, and arranged between the rotary joint 33 and the disposable syringe 34.

The fourth controlling valve 224 is mounted on the seventh pipe 377

The first controlling valve 221, the second controlling valve 222, the third controlling valve 223, and the fourth controlling valve 224 are all electromagnetic pinch valves.

The disposable fully sealed piping system having the microporous membrane filter 31, the primary filter 32, the rotary joint 33, the disposable syringe 34, the equilibrium liquid container 35, the cell suspension container 36, the enzyme solution container 38, and the pipe assembly 37, together with the instrument system having the rotary arm 21, the electromagnetic controlling valve 22, the injection pump 23, the temperature control unit for equilibrium liquid 24, the temperature control unit for cell suspension 25, and the vibrator for cell suspension 26, constitutes the above cell separation system, which could complete the process of washing tissue cells, digestion in the enzyme solution, filtering and separating cells, and washing and collecting cells. The cell separation system with simple sealed structure and being adaptable to harvest the required cells, is operated under a non-polluting environment, and helps in production of cell extraction.

The cell separation system below is in accordance with the first embodiment shown above, and a cell separation method employing this cell separation system is described. A better understanding to the structure and the function of above cell separation system could be obtained, through the description of this cell separation method.

The cell separation method is carried out by extracting adipose stem cells from the adipose tissue from the human body as raw material. The method includes the following steps (valves which are not mentioned in the steps are closed by default):

1. Heating the equilibrium liquid, and connecting the containers for one time use, the filter, syringe and the pipe assembly together.

The certain temperature set in the temperature control unit for equilibrium liquid 24 is 37° C., the equilibrium liquid container 35 is arranged in the temperature control unit for equilibrium liquid 24, to heat the equilibrium liquid until its temperature reaches 37° C., and the equilibrium liquid with 37° C. is not only used to prepare collagenase solution, but also provide cell washing liquid. The instrument system is connected to the piping system: the first pipe 371 is connected to the cell suspension container 36, the second pipe 372 is connected to the equilibrium liquid container 35, the seventh pipe 377 is connected to the enzyme solution container 38, the disposable syringe 34 is connected to the injection pump 23, the rotary joint 33 is mounted on the holder, the microporous membrane filter 31 is mounted on the rotary arm 211.

2. Digesting adipose tissue in the enzyme solution.

The adipose tissue is put into the cell suspension container 36, which is not a PVC infusion set. The equilibrium liquid whose volume equals to that of the adipose tissue is extracted from the equilibrium liquid container 35, and is poured into the enzyme solution container 38. In this embodiment, the equilibrium liquid which is lactated ringer's solution, is mixed with the collagenase which is taken according to the enzymatic activity described in the collagenase product description, to form the enzyme solution for digesting adipose tissue, and the enzyme solution in the enzyme solution container 38 is poured into the cell suspension container 36. The certain temperature set in the temperature control unit for cell suspension 25 is 37° C. And then the vibrator for cell suspension 26 which the cell suspension container arranged on starts to oscillate, the speed is 100 RPM, the time is 20-40 minutes, the digestion time is adjusted based on the enzymatic activity and the adipose tissue digestion degree.

The adipose tissue is digested by the enzyme solution to be divided into three layers from bottom to top—water solution layer, emulsus solution layer, and oil layer. The adipose stem cells are arranged in the water solution layer the emulsus solution layer. Since the bottom of the cell suspension container 36 is connected to the first pipe 371, the injection pump is set to filter and separate cells from the cell sap. Furthermore, in other embodiment of the present invention, if the raw material is other tissue, the layering of the solution might not be three layers shown in above embodiment, but the cell sap amount is under controlled, the skilled in the art only does some adjustments, and the target cells are still obtained.

3. Filtering out the impurities and molecules using the filter device, separating and extracting cells using the microporous membrane filter.

In step one, parameters of the filtering process, the centrifuge process and the separation process are set in the computer. The first controlling valve 221 is opened, and the water-soluble cell suspension in the bottom layer in the cell suspension container 36 is drawn out using the disposable syringe 34 which is driven by the injection pump 23. At this point, the cell suspension flows through the primary filter 32, which could filter out the undigested tissue and impurities, etc.

In step two, the first controlling valve 221 is closed, and the third controlling valve 223 is opened, the cell suspension is drawn by the disposable syringe 34 which is driven by the injection pump 23, to run through the fourth pipe 374, the rotary joint 33 and the fifth pipe 375 to pour into the front cavity of the rotating microporous membrane filter 31, and water, smaller biomolecules and collagenase run into the rear cavity through the filter pores, and then run into the waste collection tank 27 through the sixth pipe 376. The cells are remained in the front cavity, and flung from the filter membrane owing to the centrifugal force, which avoids membrane fouling. The rotating radius of the rotary arm is 20 cm and the rotation speed of the rotary arm is 1500 revolutions per minute.

In step three, the above processes are repeated, until the cell suspension which is under the oil layer in the cell suspension container is draw out completely.

In order to increase efficiency on cell separation, the equilibrium liquid could be poured into the pipe assembly repeatedly and the cell filtering process could be also conducted repeatedly, the steps in detail are as flow: the second controlling valve 222 is opened, the equilibrium liquid with temperature 37° C. in the equilibrium liquid container 35 is drawn out, in this embodiment, the equilibrium liquid 100 ml. And then the second controlling valve 222 is closed, and the first controlling valve 221 is opened, and the equilibrium liquid is injected into the cell suspension container 36, and the step two is repeated, so as to obtain cells in the emulous solution layer.

4. Washing cells in the microporous membrane filter using the equilibrium liquid.

Firstly, the second controlling valve 222 is opened, and the equilibrium liquid in the equilibrium liquid container 35 is drawn out using the disposable syringe 34.

Then, the second controlling valve 222 is closed, the third controlling valve 223 is opened, to make the equilibrium liquid run into the front cavity of the microporous membrane filter 31 through the fourth pipe 374, so as to wash the cell sap in the front cavity, and remove the harmful small molecular. The washing liquid in this embodiment is 150 ml.

This washing step is carried out for removing cells or enzyme in the cell sap.

5. Removing the microporous membrane filter 31, and sealing it.

The microporous membrane filter 31 is removed, and the cell sap in it could be used directly. In this embodiment, the inlet tube and the outlet tube are cut by a thermal scissors and sealed, so that the microporous membrane filter stores cells for use. The microporous membrane filter 31 is oscillated by a vibrator just before used.

The cell separation method achieves a series of processes, such as digesting tissue, filtering cells, gaining cells and collecting cells automatically, which are carried out in the disposable fully sealed piping system, avoiding pollution due to exposing in external circumstances, reducing cell mechanical trauma in the operation, and harvesting high cell survival rate.

In other embodiments of the present invention, the piping system could be different from the above embodiment, as long as the corresponding functions are achieved.

All the above are the preferred embodiments of the present invention. It is to be understood that, for one skilled in the art, the invention is intended to cover various modifications and equivalent arrangements included within the principle of the invention.

What is claimed is:

1. A centrifugal filtration device, for separating living cells, characterized by comprising a spindle, a rotary arm which is connected vertically to the spindle and rotating as the spindle rotates, and a microporous membrane filter which is mounted on the rotary arm;
wherein the microporous membrane filter comprises an inlet, an outlet, a front cavity having the inlet formed thereon, a rear cavity having the outlet formed thereon, and a filter membrane arranged between the front cavity and the rear cavity; the diameter of each filter pore formed in the filter membrane is smaller than that of the cell which needs to be separated;
the inlet and the front cavity are arranged on a far end referring to the rotary arm, and the outlet and the rear cavity are arranged on a near end referring to the rotary arm; the water in the cell suspension, the biological particle and the biomolecules pass through the filter membrane owing to the flowing fluid pressure, and the cells are blocked by the filter membrane and flung from the filter membrane to deposit in the front cavity due to the centrifugal force.

2. The centrifugal filtration device according to claim 1, characterized in that the length of the rotary arm is 10-30 cm, the rotation speed of the rotary arm is 500-1500 revolutions per minute, and the centrifugal force produced by the rotary arm is 100-500 g.

3. The centrifugal filtration device according to claim 1, characterized in that the cross section of the microporous membrane filter is round or square.

4. The centrifugal filtration device according to claim 1, characterized in that the diameter of the filter pore formed in the filter membrane is 1-30 um.

5. The centrifugal filtration device according to claim 1, characterized in that the filter membrane is made of polyolefins or polyamides material.

6. The centrifugal filtration device according to claim 5, characterized in that the filter membrane is made of polypropylene, mixed cellulose, PE material or nylon material.

7. The centrifugal filtration device according to claim 1, characterized in that the inlet of the microporous membrane filter is connected to a inlet tube, which is connected to a piping assembly via a rotary joint; and the rotary joint is mounted on a holder which is arranged up over the axis of the rotary arm, a fixed component of the rotary joint is communicated to the piping assembly, a rotary component of the rotary joint is communicated to the microporous membrane filter via the inlet tube, and the microporous membrane filter is capable of filtering cell suspension continuously while the spindle revolves.

8. A cell separation system, characterized by comprising:
a disposable fully sealed piping system and an instrument system;
wherein the disposable fully sealed piping system comprises a microporous membrane filter, a primary filter, a rotary joint, a disposable syringe, an equilibrium liquid container, a cell suspension container, an enzyme solution container, and a pipe assembly;
the microporous membrane filter comprises an inlet, an outlet, a front cavity having the inlet formed thereon, a rear cavity having the outlet formed thereon, and a filter membrane arranged between the front cavity and the rear cavity; the diameter of each filter pore formed in the filter membrane is smaller than that of the cell which needs to be separated; the inlet and the front cavity are arranged further away from the point where the centrifugal force is produced than the outlet and the rear cavity are arranged, and the water in the cell suspension, the biological particle and the biomolecules pass through the filter membrane owing to the flowing fluid pressure, and the cells are blocked by the filter membrane and flung from the filter membrane to deposit in the front cavity due to the centrifugal force;
the pipe assembly comprises a first pipe, a second pipe, a third pipe, a fourth pipe, a fifth pipe, a sixth pipe, and a seventh pipe;
the cell suspension container is arranged upside down, whose opening is communicated to the first pipe; the primary filter is mounted on the first pipe;
the equilibrium liquid container is arranged upside down, whose opening is communicated to the second pipe, and the second pipe is connected to the first pipe;
one end of the third pipe is communicated to the junction between the first pipe and the second pipe, and the other end is communicated to the disposable syringe;
one end of the fourth pipe is communicated to the disposable syringe, the other end is communicated to a fixed end of the rotary joint;
one end of the fifth pipe is communicated to a rotary end of the rotary joint, the other end is communicated to the inlet tube of the microporous membrane filter;
one end of the sixth pipe is communicated to the outlet of the microporous membrane filter, and the other end is communicated to a waste collection tank;
one end of the seventh pipe is communicated to the junction between the first pipe and the second pipe, and the other end is communicated to the enzyme solution container;
the instrument system comprises a rotary arm assembly, an injection pump, a temperature control unit for equilibrium liquid, a temperature control unit for cell suspension, a vibrator for cell suspension, and an electromagnetic controlling valve;
an end of the rotary arm assembly is mounted on the microporous membrane filter, a spindle which drives the rotary arm and a rotation axis of the rotary joint are on a straight line;
the disposable syringe is controlled by the injection pump; the temperature control unit for equilibrium liquid is arranged outside the equilibrium liquid container, to heat the equilibrium liquid and control its temperature; the temperature control unit for cell suspension is arranged outside the cell suspension container, to heat the cell suspension and control its temperature; the cell suspension container and the temperature control unit for cell suspension are arranged on the vibrator for cell suspension, which oscillates the cell suspension container automatically with the frequency predetermined by a computer;
the electromagnetic controlling valve comprises a first controlling valve, a second controlling valve, a third controlling valve, and a fourth controlling valve;
the first controlling valve is mounted on the first pipe, and arranged in front of the junction between the first pipe and the second pipe;
the second controlling valve is mounted on the second pipe;
the third controlling valve is mounted on the fourth pipe, and arranged between the rotary joint and the disposable syringe;
the fourth controlling valve is mounted on the seventh pipe.

9. The cell separation system according to claim 8, characterized in that the diameter of each filter pore formed in the primary filter is larger than that of the target cell, and the diameter of the filter pore of the primary filter is 200-300 mesh.

10. The cell separation system according to claim 8, characterized in that the electromagnetic controlling valve is electromagnetic pinch valves, to control the opening and closing of the pipe assembly.

11. The cell separation system according to claim 8, characterized in that the front cavity and the rear cavity are separated by the filter membrane, the inlet is arranged at the top or a sidewall of the front cavity, and the outlet is arranged at the bottom or a sidewall of the rear cavity.

12. The cell separation system according to claim 8, characterized in that the filter membrane is hydrophilic membrane.

13. The cell separation system according to claim 8, characterized in that the diameter of the filter pore formed in the filter membrane is 1-30 um.

14. The cell separation system according to claim 10, characterized in that the filter membrane is made of polyolefins or polyamides material.

15. The cell separation system according to claim 14, characterized in that the filter membrane is made of polypropylene, mixed cellulose, PE material or nylon material.
